(19) United States
(12) Patent Application Publication
(10) Pub. No.: US 2015/0310328 A1
(43) Pub. Date: Oct. 29, 2015

(54) Neural Network Architecture, Production Method And Programs Corresponding Thereto

(71) Applicant: UNIVERSITE DE BRETAGNE SUD, Lorient (FR)

(72) Inventors: Cyrille Chavet, Lorient (FR); Philippe Coussy, Ploemeur (FR); Nicolas Charpentier, Quimperle (FR)

(21) Appl. No.: 14/647,409

(22) PCT Filed: Nov. 22, 2013
(86) PCT No.: PCT/EP2013/074518

§ 371 Date: May 26, 2015

(30) Foreign Application Priority Data
Nov. 23, 2012 (FR) 1261155

(51) Int. Cl. G06N 3/04

(52) U.S. Cl. CPC G06N 3/0445

(57) ABSTRACT

A method of producing data representing an identifier of a neuron from a cluster of L neurons belonging to a neural network having C clusters. L and C are natural integers of values greater than or equal to two. Each neuron has at least two states. The method includes, for at least one current cluster Cᵢ: producing a set E of neural states originating from at least one cluster Cⱼ, j≠i; producing a set A of coefficients of adjacency between at least one neuron of the current cluster Cᵢ, and at least one neuron of a cluster Cⱼ of the neural network j≠i; calculating, as a function of the set E of neural states, the set A of adjacency coefficients and, as a function of state(s) of the neurons of the current cluster Cᵢ, at least one winning neuron N_{G}.

### 1. CROSS-REFERENCE TO RELATED APPLICATIONS

This Application is a Section 371 National Stage Application of International Application No. PCT/EP2013/074518, filed Nov. 22, 2013, which is incorporated by reference in its entirety and published as WO 2014/079990 on May 30, 2014, not in English.

### 2. FIELD OF THE INVENTION

The invention pertains to the physical implementation of a theoretical model of a neural network. The invention relates more particular to an optimizing of an application of a neural network. The invention is aimed at making it feasible to produce processors based on a theoretical model of a neural network.

A novel theoretical model of neural networks has been designed by C. BERROU and V. GRIPPON. These novel networks, called GBNNs, are described especially in the documents [1] Vincent Gripon, Claude Berrou: “Sparse Neural Networks With Large Learning Diversity”, [2] Vincent Gripon, Claude Berrou: “Nearly-optimal associative memories based on distributed constant weight codes”, [3] X. Jiang, V. Gripon and C. Berrou: Learning long sequences in binary neural networks, Proceedings of Cognitive 2012”, [4] Vincent Gripon, Claude Berrou: “Dispositif d'apprentissage and de decodage de messages, mettant en ceuvre un réseau de neurons” (Device for learning and decoding messages, implementing a neural network), patent application No. FR1056760, the disclosures of which are referred to in the present application. There are publications that describe especially methods for creating such neural networks based on this theoretical model [5] “H. Jarollahi, N. Onizawa, V. Gripon & W. J. Gross: Architecture and Implementation of an Associative Memory Using Sparse Clustered Networks”.

Concretely, this module is based, on the one hand, on Hopfield networks (discrete-time recurrent neural networks for which the connection matrix is symmetric and zero on the diagonal) and secondly LDPC (low-density parity check) type error correction codes. A GBNN network comprises a set of clusters each comprising a set of neurons and uses the notion of a neural “clique” for the learning and recognition of information. It has been demonstrated in [1] [2] [3] [4] that the associative memory created by a GBNN network shows appreciably better performance, for an equal number of neurons, than an associative memory based on the Hopfield model. In addition, this GBNN associative memory is also resistant to errors.

The discovery of this novel model of neural networks has been widely taken up by the scientific community.

### 3. PRIOR ART

First of all we present the GBNN model and then the unique proposition for implementing this currently existing model.

### 3.1. Brief Presentation of the GBNN Model

The authors of this network have used the technique of error corrector codes to overcome the drawbacks of the Hopfield networks. An error corrector code (turbo-code, LDPC) adds redundancy to messages in order to make them more robust against noise.

It must be noted that just like the value of the neurons, the synaptic weights are Boolean values in the GBNN model, and this distinguishes them from most of the known networks (Perceptron, Hopfield and other networks), in which the synaptic weights are either integers or real numbers. More particularly, in GBNN, the synaptic weights are replaced by coefficients and the matrix of the synaptic weights is replaced by an adjacency matrix. However, although the operands are Boolean values, the computations made in GBNN are made in the domain of the integers, i.e. the partial results are integer values. In addition, the GBNN model relies on the notion of the cluster: a GBNN type neural network is thus formed by C clusters each containing L neurons (known as James) having the particular feature of not being mutually connected within a same cluster. The message (or pattern) to be learned is first of all divided into sub-messages (this is the principle of the blockwise codes): each sub-message, having a size k, is associated with A thrifty code sized L=2̂k. A thrifty code is a code containing all the binary words on {0; 1} sized n having only one bit valued 1.

The following notations are used throughout the presentation of the prior art and the invention:
L: number of neurons of a cluster (each sub-message of a cluster is sized k=log 2(L));
C: number of clusters;
N: total number of neurons in the network (therefore N=C×L);
M: number of messages learned;
n_{i,j} with i≦C and j≦L is the notation of a neuron indexed j in the cluster i;
υ(n_{i,j,} t) is the state of the neuron n_{i,j} at the instant t (the neuron can be active or inactive);
w(_{(i,j)(i′,j′)}) is the coefficient of the adjacency matrix for an oriented pair of neurons n_{i,j} and n_{i′,j′}: it indicates whether a connection exists between two neurons.

The main advantage of the GBNN network is that the network obtained has efficiency appreciably greater than that of the Hopfield networks. The number of patterns that can be memorized is in the order of: (C−1)×L^{z}/[2C^{z}×log 2(LC)], against N/(2·log(N)) in a Hopfield network.

Besides, the capacity of the network (minimum quantity of binary information that can be learned by the network) passes from N̂2/(2·log(N)) in a Hopfield network to log 2(M+1) combinations of 2 among N. For example, a Hopfield network of 256 neurons enables the creation of an associative memory that will retain about 50 words of 256 bits (giving 400 words of 32 bits) whereas a GBNN formed by four clusters of 64 neurons each (giving 256 neurons) therefore working on 4×log 2(64), could retain about 1200 words of 32 bits. The maximum quantity of binary information learned is therefore far greater than that of a Hopfield network.

### 3.2. Presentation of the Unique Implementation Described

The attractiveness of the GBNN model was immediately perceived by the scientific community. In the current state, however, only one physical implementation of this theoretical model has been described.

More particularly, this physical implementation has been described in the document “Architecture and Implementation of an Associative Memory Using Sparse Clustered Networks”: see [5] (this implementation is here below named V0).

The article [5] cited in reference proposes the first implementation on an FPGA of the GBNN (V0). The working of GBNN V0 is the following presented with reference to FIG. 1:
1. A learning phase: a new pattern is input into a matrix of synaptic weights.
2. Presentation of a partially erased message: an LDT-1 decoder is used to specify whether, in the message, certain sub-messages (therefore clusters) are erased or not.
3. The result of the LDT-1 decoding is transmitted to a “Global Decoder” (initially the iteration module serves no purpose) more specifically to the neurons (contained in the GNCE block) which will compute the integer values from the decoded message.
4. Again in the Global Decoder, the “Winner-Takes-All” is computed (in the GCCM module) and subsequently the winner neuron of each cluster takes the value 1 (all the other neurons take the value 0). It can be noted that, in the scheme of FIG. 1, the decoder LDT-2 serves no purpose (the authors have not justified its value);
5. The new state of the network is presented to the neurons, if the maximum number of iterations has not been reached (verification made in the “Iteration Module”). If the maximum number of iterations has been reached, or if the network has converged, then the value of the clusters is re-encoded (the value passes from L to k=log 2(L) bits), the message is transmitted to the user.

The approach proposed in this document has many drawbacks.

For each neuron, the proposed architecture takes the integer sum of the products of the states of the (C−1)·L remote neurons multiplied by the (C−1)·L relative coefficients of adjacency. Obviously, this results in a large number of computations which entail the use of a large number of computers working in parallel to obtain high time-related performance. This conventionally results in a very great surface and very great energy consumption. In addition, since the computations are made on integers, the propagation time of the signals in the arithmetic operators takes place along the strings of carry-over values, correspondingly slowing down the frequency of operation of the circuits (whether they are programmable processor type circuits or non-programmable dedicated type circuits).

In addition, each neuron is permanently connected to the adjacency matrix and at each iteration it receives the value of the (C−1)·L neurons to which it can be connected. As a consequence, the architecture makes it necessary to connect each of the N neurons contained in the network to all their respective remote neurons (i.e. (C−1)×L). This results in a prohibitive number of connections i.e. C×(C−1)×L² connections. The inventors have noted that certain communications are necessary: indeed, the inactive neurons have no influence on the results (the accumulation of zero results originating FROM partial products of the values of inactive neurons (hence zero values) multiplied by coefficients in the adjacency matrix). It is therefore not necessary to communicate their values. In addition, the communications could be serialized to reduce the number of connections.

In addition, the inventors have also noted that the solutions described in [5] propose memorizing the states of the connections in a square adjacency matrix. Thus, if two neurons n_{i,j} and n_{i′,j′} are connected, the matrix will contain two coefficients: a first coefficient w(_{(i,j)(i′,j′)}) for the neurons n_{i,j} and a second coefficient w(_{(i′,j′)(i,j)}) for the neurons n_{i′,j′}. The values of the coefficients w(_{(i,j)(i′,j′)}) and w((_{(i′,j′)(i,j)}) are identical since these coefficients represent the state of one and only one connection between the neurons n_{i,j} and n_{i′,j′}. The proposed architecture gives rise to a dual memorizing of the same piece of information. The size of the matrix of adjacency coefficients could therefore be divided by two and the computations made during the phase could be halved without modifying the general operation of the network.

Finally, in a GBNN network, each neuron carries out a set of computations from a set of information elements transmitted to it (i.e. the states of the remote neurons) and a set of information elements stored locally (the states of the connections stored in the local adjacency matrix). Since the states of the connections are thus memorized in the remote clusters (see the above paragraph), the partial sums of the products could be made in the remote clusters. Consequently, only the corresponding results could be transmitted, reducing the number of connections needed between the neurons to the same extent. Moreover, a large number of unnecessary information elements are communicated and used in the computations. Indeed, certain operands and certain computations are unnecessary, e.g. the inactive neurons have no influence on the results (the accumulation of zero results originating FROM partial products of the values of inactive neurons (hence zero values) multiplied by coefficients in the adjacency) matrix°.

Thus, it is necessary to propose solutions to enable the making of an architecture that can be really scaled up and is economically profitable in relation to the storage capacity created.

More particularly, the problems posed by this V0 architecture are the following:
1. an excessively great complexity of computations;
2. an excessively large quantity of memory;

3. an excessively large number of connections between the neurons;
4. mismatch between the information exchanged and the information truly needed.

These problems make it impossible to obtain large-scale implementations. They also give rise to problems of cost, frequency and/or number of data access points and energy consumption.

### 4. SUMMARY OF THE INVENTION

The invention makes it possible to at least partially overcome the defects of the previously proposed architecture and therefore the basic theoretical model itself. Indeed, the invention relates to a method for obtaining a piece of data representing an identifier of one neuron from among a set of L neurons called a cluster, L being a natural integer of a value greater than or equal to two, said cluster belonging to a neural network comprising C clusters, C being a natural integer of a value greater than or equal to 2, each neuron of said neural network comprising at least two states.

According to the invention, said method comprises, for at least one current cluster Cᵢ:
a step for obtaining a set E of states of neurons originating from at least one cluster Cⱼ, j≠i;
a step for obtaining a set A of adjacency coefficients or coefficients of adjacency between at least one neuron of said current cluster Cᵢ, and at least one neuron of a cluster Cⱼ of the neural network j≠i;
a step for computing, as a function of said state E of states of neurons, of said set A of coefficients of adjacency and as a function of at least one state among the states of said neurons of said current cluster Cᵢ, at least one winning neuron N_{G}, delivering said piece of data representing an identifier of said at least one winning neuron N_{G}.

Thus, the method of the invention makes it possible to obtain a winning neuron in a given cluster as a function of the states of the other neurons of the clusters which form part of the neural network. Depending on the embodiments, the obtaining of the sets of states is done differently.

According to one particular embodiment, said step for computing comprises, for a current neuron n_{i,j} of said current cluster Cᵢ, the application of the following formula:

$$ϑ ( {n}_{i , j} , t + 1 ) = {}_{k = 1 , k \neq i}^{C} ( ( {}_{g = 1}^{L} ϑ ( {n}_{k , g} , t ) ⋀ {w}_{( i , j ) ( k , g )} ) ( \overline{{}_{g = 1}^{L} ϑ ( {n}_{k , g} , t )} ) )$$

wherein:

[symbol] (n_{i,j},t+1) is the state of the neuron n_{i,j} at the instant t+1;

Λ_{k=1,k≠i}^{C}( . . . ) is a conjunction (logic AND) of C−1 non-zero binary elements given by the logic equations applied to all the other clusters of the neural network;

w_{(i,j)(k,g)} is the coefficient of adjacency between the neuron n_{k,g} and the neuron n_{i,j};

[symbol] (n_{k,g},t) is the state of the neuron n_{k,g} at the instant t;

V_{g=1}^{L} is the operation of disjunction (logic OR) of L binary elements representing the state (active or not active) at the instant t of the neurons of the remote clusters;

(V_{g=1}^{L} . . . ) is the operation of complemented disjunction (logic NOR) of L binary elements.

The complemented disjunction operation (logic NOR) of L binary elements makes it possible for a remote cluster k, when this cluster is active [in other words if the remote cluster contains at least one active n_{k,g}], to determine whether one (logic OR) of these active neurons n_{k,g} is connected (w_{(i,j)(k,g)}) to the neurons n_{i,j} at the instant t. If not, this complemented disjunction operation makes it possible not take account of a piece of information which would then be irrelevant.

According to one particular embodiment, said step for computing comprises a step of selection, from among the neurons of said current cluster Cᵢ, of the neuron N_{G}, the state of which at the instant t+1 is 1.

According to one particular embodiment, said step for computing comprises a step of selection, from among the neurons of said current cluster Cᵢ, of the neuron N_{G}, the state of which at the instant t+2 is 1, in applying the following function:

$$ϑ ( {n}_{i , j} , t + 2 ) = {}_{i = 1}^{L} ( ϑ ( {n}_{i} , t + 1 ) Λ {( {}_{\begin{matrix}j = 1 , \\ j \neq l\end{matrix}}^{L} ϑ ( {n}_{j} , t + 1 ) )}^{{\_}^{′}} )$$

According to one particular embodiment, said step for obtaining a set A of coefficients of adjacency originating from at least one cluster Cⱼ, j≠i comprises a plurality of steps of access to at least one centralized structure for memorizing coefficients of adjacency of neurons of said neurons of said clusters of said neural network.

According to one particular embodiment, said at least one centralized structure for memorizing coefficients of adjacency of neurons takes the form of a blockwise triangular matrix comprising a number of blocks equal to Σᵢ₌₁^{C-1} i, one block comprising L adjacency coefficients.

According to one particular embodiment, said step for obtaining a set E of states of neurons originating from at least one cluster Cⱼ, j≠i comprises L steps of simultaneous transmission by each cluster Cⱼ, j≠i, of a single state of a single neuron.

According to one particular embodiment, said step for obtaining a set E of states of neurons originating from at least one cluster Cⱼ, j≠i comprises C steps of simultaneous transmission, one per cluster Cⱼ, j≠i, of all the states of the cluster.

According to one particular embodiment, said step for obtaining a set E of states of neurons originating from at least one cluster Cⱼ, j≠i comprises, within said current cluster Cᵢ, a step for implementing a shift register of a predetermined size.

According to one particular embodiment, said predetermined size of said shift register is equal to the number of steps of simultaneous transmission.

According to one particular characteristic, said at least one cluster Cⱼ, implements at least one part of said step for computing and transmits to said cluster Cᵢ, the sum and/or the disjunction of the coefficients of adjacency of these active neurons.

According to one particular implementation, the different steps of the methods according to the invention are implemented by one or more software programs or computer programs comprising software instructions intended for execution by a data processor of a relay module according to the invention and being designed to command the execution of the different steps of the methods.

Consequently, the invention is also aimed at providing a program, capable of being executed by a computer or by a data processor, this program comprising instructions to command the execution of the steps of a method as mentioned here above.

This program can use any programming language whatsoever and take the form of a source code, object code or an intermediate code between source code and object code, such as in a partially compiled form or in any other desirable form whatsoever.

The invention is also aimed at providing an information carrier readable by a data processor and comprising instructions of a program as mentioned here above.

The information carrier can be any entity or device whatsoever capable of storing the program. For example, the medium can comprise a storage means such as a ROM, for example a CD ROM or a microelectronic circuit ROM or again a magnetic recording means such as floppy disk or a hard disk drive.

Besides, the information carrier can be a transmissible carrier such as an electrical or optical signal, which can be conveyed via an electrical or optical cable, by radio or by other means. The program according to the invention can especially be uploaded to an Internet type network.

As an alternative, the information carrier can be an integrated circuit into which the program is incorporated, the circuit being adapted to executing or to being used in the execution of the method in question.

According to one embodiment, the invention is implemented by means of software and/or hardware components. In this respect, the term “module” in this document can correspond equally well to a software component as to a hardware component or to a set of hardware or software components.

A software component corresponds to one or more computer programs or several sub-programs of a program or more generally to any element of a program or a software package capable of implementing a function or a set of functions, according to what is described here below for the module concerned. Such a software component is executed by a data processor of a physical entity (terminal, server, gateway, router, etc) and is capable of accessing hardware resources of this physical entity (memories, recording media, communications buses, input/output electronic boards, user interfaces, etc).

In the same way, a hardware component corresponds to any element of a hardware assembly capable of implementing a function or a set of functions according to what is described here below for the module concerned. It may be a programmable hardware component or a component with an integrated processor for the execution of software, for example an integrated circuit, a smartcard, a memory card, an electronic card for executing firmware, etc.

The different embodiments mentioned here above can be combined with one another to implement the invention.

### 5. FIGURES

Other features and advantages of the invention shall appear more clearly from the following description of a preferred embodiment, given by way of a simple illustratory and non-exhaustive example, and from the appended figures, of which:

FIG. 1, already introduced, describes a proposed implementation of a GBNN neural network;

FIG. 2 illustrates a synaptic connection matrix in a simplified network of three clusters each comprising three neurons;

FIG. 3 represents a link between two neurons and the adjacency coefficients;

FIG. 4 represents a non-optimized matrix in which the information is stored twice;

FIG. 5 represents an optimized matrix according to one embodiment of the invention;

FIG. 6 represents the updating of the neural network in a serial-cluster configuration;

FIG. 7 represents the updating of the neural network in a serial-neural configuration;

FIG. 8 represents the logic system normally necessary for learning and rendering of adjacency coefficients in the serial matrix or neural case;

FIG. 9 represents a shift register according to the prior art;

FIG. 10 represents a flip-flop ring according to the invention;

FIG. 11 represents the information stored in a non-triangularized matrix and the way in which the information on the neurons of each cluster can be retrieved (row access);

FIGS. 12, 13 and 14 represent the ways in which respectively three clusters A, B and C access the same information as that of FIG. 11 in the triangularized matrix;

FIG. 15 represents an example of use of a flip-flop ring on one of the sub-matrices in a series-cluster communication and in parallel processing;

FIG. 16 represents the implementation of two series of flip-flop rings for row access and column access to a sub-matrix in the context of serial cluster communications and serial cluster processing;

FIG. 17 represents the implementation of diagonal flip-flop rings in a particular embodiment of the invention.

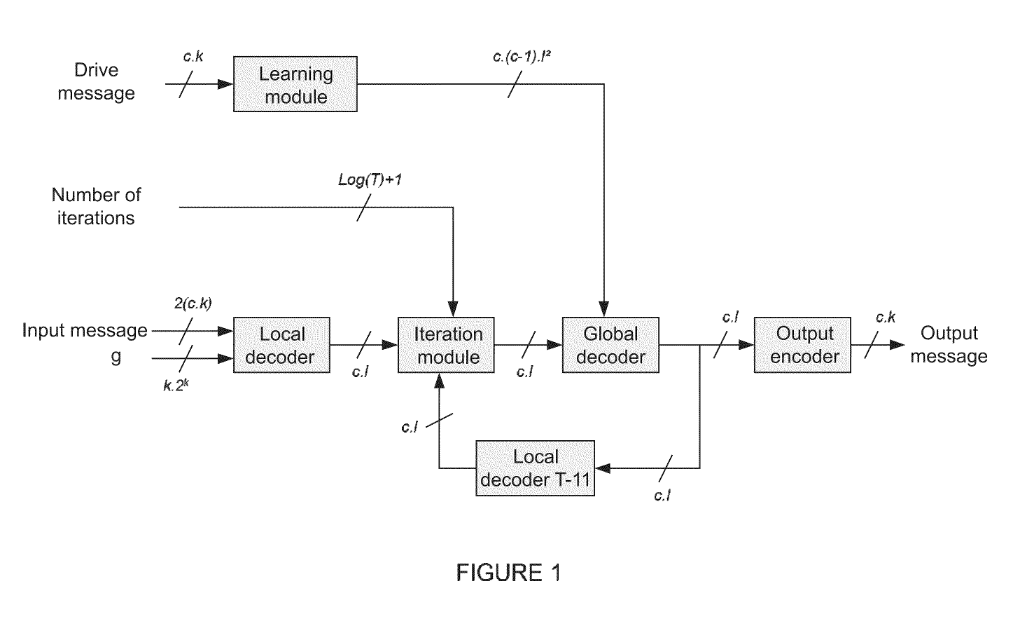

### 6. DESCRIPTION OF EMBODIMENTS

### 6.1. Reminder of the General Principle

The general principle of the invention relies, in at least one embodiment, on the improvement of the implementing of the GBNN model. More particularly, the solution for existing digital integrated circuits (such as the one proposed in “Architecture and Implementation of an Associative Memory Using Sparse Clustered Networks”) is actually a simple transposition of the theoretical model to a digital hardware architecture without identifying the limits of such a transposition. Now, for this transposition of the model to a digital integrated circuit to be economically and technologically viable in a scaling-up or large-scale implementation, it is necessary precisely to identify the limits of this transposition and to propose solutions to resolve the problems raised. Complementarily, the identification of the limits of the transposition also makes it possible to identify the limits of the theoretical model, as explained here below.

The inventors have succeeded in identifying these limits, and this is one of the constituent elements of the invention. Indeed, in addition to providing optimization, one of the difficulties lay in identifying the problems raised and the source of these problems. More particularly, the inventors have identified the fact that to enable the large-scale implementation the initially proposed architecture, it was necessary to modify the way in which the computations, the communications and the memorization was done but also to modify the type of information exchanged. Each of the modifications made in the original architecture is independent of the other modifications and each of these modifications drastically reduces the costs of the initial architecture. Naturally, when all the optimizations are combined, the reduction is such that the architecture becomes technologically plausible and economically exploitable under current conditions.

More specifically, as presented in detail here below, the optimizations relate to:
The simplification of the computations to be made: the inventors have shown that it is possible to greatly simplify the complexity of the computations in working only on Boolean information by means of logic equations while at the same time keeping the operation and logic of the GBNN networks intact.
The reduction of the size of the matrix (and of the memory chip): the inventors have shown that it is possible to drastically reduce the adjacency matrix by reducing its size substantially while keeping its logic function intact. More particularly, the inventors have identified a method to reduce this matrix. Thus, the physical implementation of this matrix, which also relates to the matrix name, is reduced in size. More particularly, the memory component of the matrix has reduced size.
The reduction of the number of connections: the inventors have shown that is possible to reduce the number of connections between the neurons by modifying the way in which the clusters of neurons communicate with each other.
The complexity of the architecture of the network: the inventors have shown that it is possible to reduce the complexity of the architecture by modifying the type of information exchanged between the clusters and the neurons.

These last two points reduce the number of connections on the circuit.

Thus, the invention makes it possible to divide the number of logic units needed to make such a circuit almost by ten. This reduction of the surface is accompanied by an improvement in time-related performance through the increasing of the operating frequency of such a circuit, but also through a reduction in the energy consumption through the reduction of the number of points of access to the memories, the number of communications and the simplifying of the computations.

The general principle of the invention can also be implemented by modifying or creating a logic code that can be executed by one or more processors (CPU, GPU, etc.). In this case, the improved architecture of the invention takes the form of an optimized executable code. The advantages drawn by this executable code are however the same or of the same nature as those of an implementation on a digital/physical circuit.

Each of these optimizations gives rise to one embodiment of the invention. The combination of these optimizations gives rise to a novel embodiment. Besides, the optimization studies carried out on this architecture have led the inventors to define an improved version of the initial model by replacing the data exchanged between the clusters by new data. This is therefore a fifth optimization of the initial architecture. According to the invention, in this fifth embodiment, called a “Super Neuron” embodiment, each cluster is seen as a single neuron in the binary state. As presented here below, in this fifth embodiment, a cluster, depending on the sub-message transmitted to it, plays the role alternately of one neuron after another of the L neurons that form it. In other words, in this fifth embodiment, the cluster is a reconfigurable neuron (i.e. the cluster plays the role of a single neuron at a given point in time).

In general, and from a certain point of view, the invention can be described as a method for obtaining at least one winning neuron N_{G}. As compared with the prior art described here above, the winning neuron is obtained by applying at least one of the optimizations made. Thus, the invention, in at least one embodiment, relates to a method for obtaining a piece of data representing an identifier of a neuron from among a set of L neurons called a cluster, L being a natural integer with a value greater than or equal to two, said cluster belonging to a neural network comprising C clusters, C being a natural integer with a value greater than or equal to two, each neuron of said neural network comprising at least two possible states (for example lit/extinguished, on/off, 0, 1).

According to the invention, the method comprises, for at least one current cluster C, within an iterative updating process, neurons and/or clusters of the neural network:
a step for obtaining a set E of a states of neurons originating from at least one cluster Cⱼ, j≠i; at this step, current steps are obtained coming from distant clusters (hence from distant neurons).
a step for obtaining a set A of coefficients between at least one neuron of said current cluster Cᵢ, and at least one neuron of a cluster Cⱼ of the neural network j≠i; in this step, for example, we obtain the coefficient of adjacency of the first neuron of the current cluster with the first neuron of each remote cluster or again the coefficients of adjacency of all the neurons of the current cluster with all the neurons of a remote cluster;
a step for computing, as a function of said set E of states of neurons, of said set A of coefficients of adjacency and, as a function of at least one state among the states of said neurons of the current cluster Cᵢ, of at least one winning neuron N_{G}, delivering said piece of data representing an identifier of said at least one winning neuron N_{G.} An updating is therefore done of at least one state of the current cluster to find the winning neuron (i.e. the neuron of the current cluster which is in the lit state, i.e. the state 1, while the other neurons of the current cluster are in the extinguished state, i.e. 0).

Each of the steps of this method relates to at least one of the optimizations presented here above. For example, the computation step is performed by carrying out a binarization of the computations for obtaining the winning neuron or neurons and/or for the WTA mechanism. The steps for obtaining sets of states and coefficients are performed either locally or in a centralized way as a function of the embodiments described here below. In the “Super Neuron” embodiment, each cluster sends the sum or disjunction (depending on whether it is integer computation or binary computation) of the adjacency coefficients of its active neurons instead of sending the state of the neurons. This means that the sets A and E described here above are really obtained but that at least one part of the computation is done at the cluster Cⱼ, and the transmitted information is different from the information transmitted in the other embodiments.

Naturally, as described here below, it is possible to represent the invention directly in the form of a system integrating modules that can take charge of the optimizations described. In another form, the invention can also be seen as an electronic circuit that directly integrates electronic components to implement the invention. In this case, the components are laid out so that they can carry out the learning and recognition of messages by means of the hardware optimizations proposed (shift registers, multiplexes, physical transpositions of logic equations, etc.). The system can therefore be polymorphous, depending on the form of implementation of the method. The invention can also be implemented in the form of a microprocessor. The invention can also be implemented in the form of a device or special processor that is adjoined to a circuit or to an Existing Processor in Order to Enable the Technique of the Invention to be Taken into Account.

### 6.2. Descriptions of Embodiments (Successive Optimizations)

### 6.2.1. Binarisation of the Computations: Square Matrix Version (V1)

The idea of the basic matrix version is to optimize the logic of computation of the architecture: the basic version of the architecture (V0) proposes integer computations. The first optimization made (version V1) passes to binary computation.

Thus, in each cluster, the proposed architecture (version V1) replaces the integer sum of the products of the states of the (C−1)·L remote neurons by the (C−1)·L relative coefficients of adjacency obtained by means of a logic equation handling Boolean variables. In addition, the proposed architecture (version V1) no longer requires, as is the case in the theoretical model, the performance of computations related to the WTA to take a “flexible” decision (i.e. in each cluster, to define which are the different active neurons if we consider that several neurons can be active in a cluster). Besides, in order to take a “hard” decision (i.e. define which is the only active neuron), which is not proposed in the initial theoretical module, the WTA is replaced by a simple logic equation handling Boolean variables. In other words, whatever the type of decision taken, a summing of integers and a comparison between the sums obtained are replaced by a logic equation, which consumes far less computation capacity.

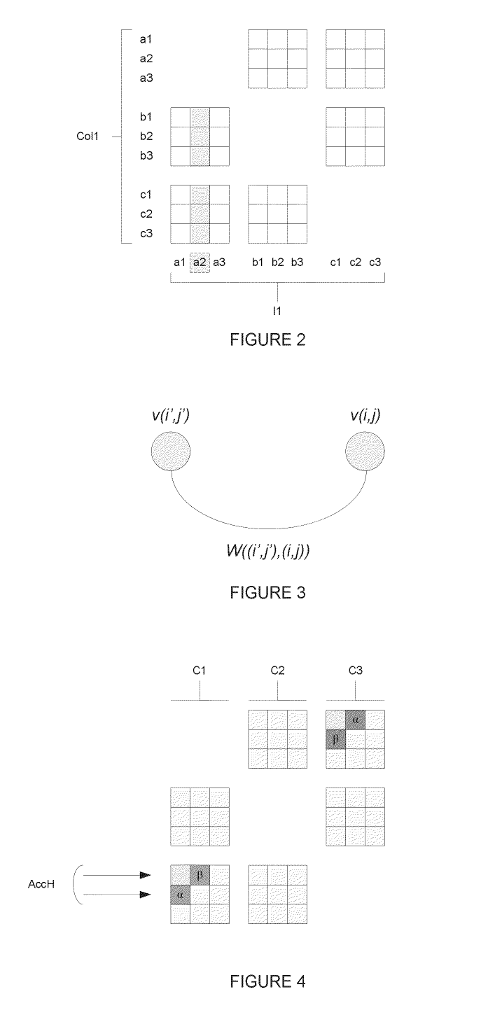

By way of an illustration of the principles of this embodiment, we have chosen a pedagogical network model (three clusters of three neurons each) which makes it possible to understand the principle of this optimization. Referring to FIG. 2, we present the matrix of the synaptic connections (connections between all the neurons of the network) without the diagonal since the neurons of a same cluster are not connected to each other (the weights of the connection is therefore systematically zero, and it is not necessary to store the information).

In FIG. 2, each column represents the connections of a neuron of the network (there are L×C=3×3=9 neurons in all) towards the L neurons of the (C−1) remote clusters (3×2). The value of the neuron at a certain instant t (in figure, a2, which is surrounded by dashes) appears on the row (11) beneath the network. This row is a binary word which represents the state of the network at the instant t. At the instant (t+1), this word will be used to compute a new state. This is represented by the column to the left of the matrix (Col1).

The learning process (memorizing of coefficients in the adjacency matrix, i.e. in the GBNN model, the memorizing of the existence or non-existence of a connection between two neurons) is not described in detail in this embodiment because it is appreciably identical to that of the version V0.

The validity from the viewpoint of the initial model, of the passage from a piece of “integer” type data to a piece of “binary” type data is demonstrated as follows: the value of a neuron is computed according to the values of the other neurons, and the connections between these neurons. The initial equation can be reduced to a simpler logic equation to be implemented: the idea of the inventors is to work henceforth only with logic operators and binary values (in the version V0, the value of a neuron is first of all an integer and then the cluster chooses that one of its neurons which has the greatest value, this is the WTA principle).

The passage from a computation of integers to a computation of Boolean values is done by observing that, in a cluster, at the end of the WTA, only one neuron has been chosen (when the situation relates to a case of “hard” decision making, see here below). Consequently, when sending its values, this cluster will transmit only one bit at 1 and all the other bits at 0.

When the operation is placed at the level of a cluster that receives information from remote clusters, in the version V0, each neuron must take the sum of its inputs weighted by the value of the coefficient of the adjacency matrix (either 0s or 1s). However, the inventors have found that it is not necessary to take an integer sum: it is enough to perform a simple logic AND operation on the value transmitted by all the remote clusters. If the Boolean result of this operation is 1, then it means that the current neuron is on the clique on which the remote neurons are situated. Indeed, this result, in terms of integer value, would give (C−1).

By way of an example, the following is the simplified equation for updating (instant t+1) the first neuron (a1) of the first cluster (A) in the case of a network of three clusters of three neurons each: a₁(t+1)=((b₁(t)·wₐ_{₁}_{,b}_{₁}+b₂(t)·wₐ_{₁}_{,b}_{₂}+b₃(t)·wₐ_{₁}_{,b}_{₃})+ b̅₁̅(̅t̅)̅+̅b̅₂̅(̅t̅)̅+̅b̅₃̅(̅t̅)̅ b̅₁̅(̅t̅)̅+̅b̅₂̅(̅t̅)̅+̅b̅₃̅(̅t̅)̅ b̅₁̅(̅t̅)̅+̅b̅₂̅(̅t̅)̅+̅b̅₃̅(̅t̅)̅)·((c₁(t)·wₐ_{₁}_{,c}_{₁}+c₂(t)·wₐ_{₁}_{,c}_{₂}+c₃(t)·wₐ_{₁}_{,c}_{₃})+ c̅₁̅(̅t̅)̅+̅c̅₂̅(̅t̅)̅+̅c̅₃̅(̅t̅)̅ c̅₁̅(̅t̅)̅+̅c̅₂̅(̅t̅)̅+̅c̅₃̅(̅t̅)̅ c̅₁̅(̅t̅)̅+̅c̅₂̅(̅t̅)̅+̅c̅₃̅(̅t̅)̅) The neuron a₁ of the cluster A: will be active at the instant t+1 if at the instant t:
the neuron b₁ of the cluster B is active and is connected to the neuron a₁ i.e. b₁ AND w_{a1,b1} are equal to 1, or
the neuron b₂ of the cluster B is active and is connected to the neuron a₁ i.e. b₂ AND w_{a1,b2} are equal to 1, or
the neuron b₃ of the cluster B is active and is connected to the neuron a₁ i.e. b₃ AND w_{a1,b3} are equal to 1, or
all three neurons b₁, b₂ and b₃ are inactive i.e. they are equal to 0 or
the neuron c₁ of the cluster C is active and is connected to the neuron a₁ i.e. c₁, AND w_{a1, b1} are equal to 1, or
the neuron c₂ of the cluster C is active and is connected to the neuron a₁ i.e. c₂ AND w_{a1,c2} are equal to 1, or
the neuron c₃ of the cluster C is active and is connected to the neuron a₁ i.e. c₃ AND w_{a1,c3} are equal to 1, or
the three neurons c₁, c₂ and c₃ are inactive i.e. are equal to 0.

In other words, a neuron will be potentially active if it is connected to at least one of the active neurons in each of the clusters having active neurons (i.e. if it belongs to the current clique).

One condition for this equation to be valid is to overlook the extinguished clusters, (i.e. clusters not containing active neurons): for example, if no neuron of the cluster B is active (i.e. if the sub-message of the cluster B is erased), then the logic AND operation that the neurons of the other clusters will perform should not be falsified by the values of B. By adding a NOR function to all the neurons of each cluster, we obtain the desired behavior: a cluster that contains no active neurons remains transparent and therefore does not interfere in the result. Concretely, the adjoining of the NOR to all the neurons maintains the property of the initial model according to which the recognition is possible even with a partial message.

The above equation can be generalized as follows for C clusters and N neurons in using the notations provided previously (and the general notations of Boole's algebra):

$$ϑ ( {n}_{i , j} , t + 1 ) = {}_{k = 1 , k \neq i}^{C} ( ( {}_{g = 1}^{L} ϑ ( {n}_{k , g} , t ) {w}_{( i , j ) ( k , g )} ) ( \overline{{}_{g = 1}^{L} ϑ ( {n}_{k , g} , t )} ) )$$

The value (υ(n_{i,j,} t+1)) which is not zero at the instant t+1 of a current neuron n_{i,j}, (i being the identifier of the cluster and j being the identifier of the neuron in the cluster i) is the result of a conjunction (logic AND, Λ_{k=1,k≠i}^{C}( . . . )) of non-zero results given by the logic equations applied to all the other clusters of the neural network. These logic equations make it possible, for each remote cluster k, to determine when this cluster is active (logic NOR on the υ(n_{k,g}, t) values) [in other words, if the remote cluster contains at least one active neuron n_{k,g}], if a (logic OR) of these active neurons n_{k,g} is connected (w_{(i,j)(k,g)}) to the neuron n_{i,j} at the instant t.

In order to take a “flexible” decision (i.e. to define which are the different active neurons in each cluster when it is considered that several neurons can be active in a cluster), no additional computation is necessary relative to the previous one.

However, in order to take a “hard” decision (i.e. in order to define which is the unique active neuron when it is considered that a unique neuron can be active in a cluster), the WTA is replaced by the following logic equation:

$$ϑ ( {n}_{i , j} , t + 2 ) = {}_{i = 1}^{L} ( ϑ ( {n}_{i} , t + 1 ) Λ {( {}_{\begin{matrix}j = 1 , \\ j \neq l\end{matrix}}^{L} ϑ ( {n}_{j} , t + 1 ) )}^{{\_}^{′}} )$$

In addition, unlike in the original model of the GBNN, the performance of all the computations in binary mode intrinsically enables the network not to produce false positives and not to provide erroneous solutions as described in reference [2].

### 6.2.2. Optimising the Memory: Triangle Matrix Version (V1.0)

In the GBNN version as described originally, a message can be represented by a non-oriented graph whose nodes are words of the message. The architects of the version V0 limited themselves to this implementation which is strictly identical to the model. The existence of the connections between the words, i.e. the existence of an edge between two nodes of the graph is therefore stored in a symmetric matrix. However, there is a redundancy of information in this symmetric matrix. Indeed, the existence or non-existence of an edge connecting two nodes x and y of the graph is memorized by means of two memorizing elements: a first memorizing element is associated with the node x and, by means of one bit, stores the existence or non-existence of an edge with the node y; a second memorizing element is associated with the node y and, by means of one bit, stores the existence or non-existence of an edge with the node x. Thus, in such a matrix, each row represents the connections between a neuron and all the other neurons of all the other clusters, and each cluster is represented by a group of rows (one for each of its neurons). This redundancy is not negligible.

Now the inventors have found that it is possible, without losing information, to halve the number of memorizing elements needed for the storage of the coefficients. The computation logic is not affected, since the number of neurons (peaks of the graph) is not reduced. This is illustrated with reference to FIGS. 4, 5 and 6. In this version, to represent the interconnections between two clusters C₁ and C₂, the coefficients of adjacency (i.e. the connections) of the neurons of C₁ with those of C₂ are found by reading the corresponding sub-matrix in rows; the coefficients of adjacency of the neurons of C₂ with those of C₁ are found by reading this same corresponding sub-matrix in the columns.

FIG. 3 illustrates two peaks (i.e. two neurons), v(i′,j′) and v(i,j) of a non-oriented graph. The edge between these two neurons is w((i′, j′), (i,j)): this is the coefficient of adjacency or adjacency coefficient. The non-optimized version of the memory limits itself to storing the same information element twice, as illustrated in FIG. 4. This figure presents a non-optimized matrix of the adjacency coefficients on a network of three clusters of three neurons each. The cells α and β store the same weight at two different places. This type of matrix is implemented in the version V0. For example, the a represents the connection between the second neuron of the first cluster and the first neuron of the third cluster.

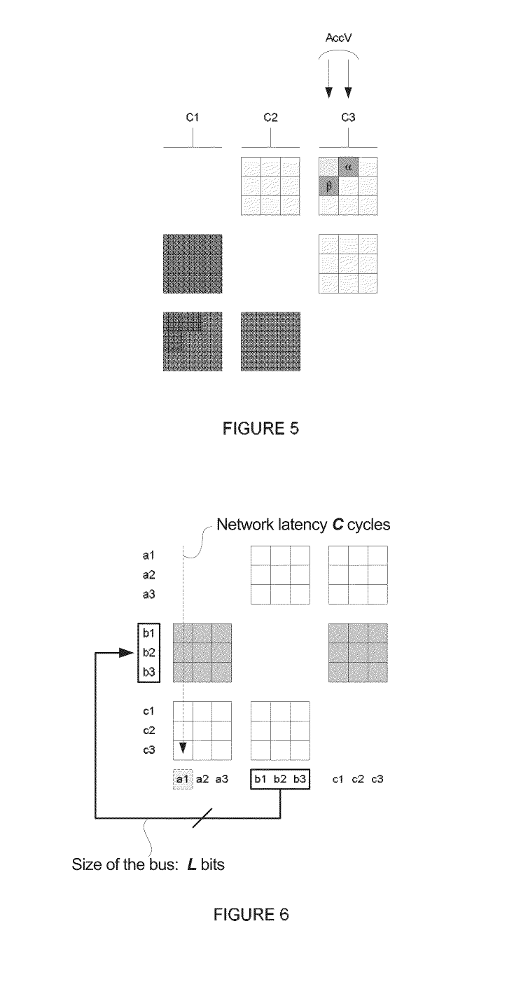

The inventors have had the idea of modifying this matrix to reduce the resources allocated to the memory. The optimization consists in storing the adjacency coefficient of two neurons at only one place. Thus, the invention passes from a square matrix to a blockwise triangular matrix. Naturally, the general architecture is modified. It is indeed necessary to draw two tracks (or make two access points) towards this single memory point to feed the operators of the two concerned neurons so that each of these two neurons can have access to the information. However, since these tracks already exist in the square matrix, this optimization does not result in any increase in the number of tracks or signals (or number of access points in the context of a software implementation). Thus, no increase is generated and this is an advantage. FIG. 5 illustrates the leveling of the adjacency matrix on a network of three clusters of three neurons. The redundant information elements relating to the connections between neurons are eliminated (cells at the bottom left-hand). There is then a blockwise triangular matrix available. The blocks of the diagonal represent the connection of each cluster with itself and are therefore at zero. We therefore have a number of blocks equal to Σᵢ₌₁^{C-1} i. For three clusters, as in FIG. 4, we therefore obtain a triangular matrix by blocks, comprising three blocks. For four clusters, we obtain six blocks. For five clusters we obtain ten blocks, etc. Each block comprises a number L of adjacency coefficients.

Thus, while keeping the number of tracks or access points unchanged, the optimization made is important in terms of memory points. Indeed, the number of bits of the matrix is of the order of L²C², specifically L²*C*(C−1), in the version VA (a matrix of LC*LC bits, from which the diagonal has been eliminated since the neurons of the same cluster cannot be connected to each other). A leveling of the matrix (elimination of the lower triangle) makes it possible to arrive at 0.5*L²*C*(C−1), which therefore gives substantial savings since these embodiments represent increasing orders of magnitude relative to the architecture V0. To enable access to the information stored in this triangular matrix, a modification is made in the direction of reading of certain data. Indeed, the pieces of data that were memorized at memory points eliminated by the triangularization of the matrix were preliminarily read in rows. They must therefore henceforth be read in columns. More particularly, the horizontal access AccH to the adjacency coefficients α and β of FIG. 4 is done, after application of the optimization of triangularization (i.e. elimination of the lower left-hand part of the matrix as described in FIG. 5), by a vertical access AccV. The technical details of these access points are given here below.

Besides, a major corollary effect is obtained unexpectedly: the learning resource, i.e. the logic that makes it possible to give the different coefficients of the matrix their value, is also halved: indeed, since the number of coefficients is divided by two, the logic that enables these coefficients to be written is reduced by an equivalent value.

Thus, as compared to the version V0, the inventors have been able not only to reduce the computation resources but also the memory and learning resources. About 50% of the surface area is thereby gained by this optimization.

### 6.2.3. Serialising Communications: Serial Matrix Version

In one embodiment of the invention, rather than drawing a track between each pair of remote neurons (to make them transmit information), a serialization is carried out on the transfer of data between clusters. Indeed, since the clusters exchange information during the rendering (and in certain models during the learning), the reduction of the connections between clusters requires the serialization of the data: if a cluster must transmit L values to all the other clusters, we have initially L²*C*(C−1) icons in the network of interconnections between clusters (here below, the term RIC is also used to designate the “network of interconnections between clusters”). This serialization consists in implementing several steps to enable a transfer of the pieces of data one after the other.

In enabling a cluster to distribute a bit that it receives among all its neurons, the operation passes to L*C*(C−1) tracks, which is a first optimization. By serializing the transfers, the number of tracks of the interconnection network between clusters is reduced and the computation resources used are pooled since the neurons (or the clusters) use these resources in turn (i.e. they receive information pertaining to them). The inventors have identified two axes of serialization:
Serialization by clusters: at each iteration, one and only one cluster sends the value of all its neurons on the interconnection network (RIC), (the RIC therefore comprises L tracks).
Serialization by neurons: at each iteration, each cluster transmits on the network the value of one and only one of its neurons (the RIC therefore comprises C tracks).

The serialization implies an increase in latency, respectively by a factor L or C. Serialization also implies the introduction of a sequencer in the architectures as well as a selection and routing circuitry. The sequencer is an automaton (or finite states machine) comprising L or C, depending on whether the serializing is done by neurons or by clusters.

The selection and routing circuitry requires the use of a series of multiplexers (conventionally organized in arborescent form) enabling the selection if necessary of a cluster or a neuron. In addition, to drive these multiplexers, an addressing vector (obtained by transcoding of the state register of the sequencer) would be necessary and would increase the cost of such an approach to an equivalent degree. The excess cost of adding such multiplexers and of the associated logic is such (see FIG. 9) that the optimization proposed could, at least in certain cases, lose its utility (loss or zero gain). However, the inventors have circumvented this problem of sequencing by using an ingenious technique: special circular shift registers (also called flip-flop rings) can thus be exploited. Thus, the desired information is memorized directly in the shift register (see FIG. 11) and then it is the very property of “shifting” that is used to sequence the transmission of information on the interconnection network. This size of the shift register used is, in one particular embodiment, equal to the number of steps of simultaneous transmission of information (CorL) as explained here below.

Here below, we present the two identified serialization axes which enable the basic architecture to be optimized.

### 6.2.3.1. Serialisation of the Clusters: Serial Cluster Matrix Version (V1.1)

In this embodiment of the invention, the updating of the network, i.e. an iteration of decoding takes C steps (namely one step per cluster of the neural network). As illustrated in FIG. 6, for a network with three clusters of three neurons each, at each step one and only one cluster transmits the value of all its neurons to the others (there are therefore L tracks on the bus of the interconnection network bus between clusters).

The logic equation described in the version V1 is still applicable but depending on the embodiments, the intermediate results are stored (the time taken to receive the totality of the data); here is an example of the updating of the first neuron of the first cluster if there are clusters C in the network (there are C updating steps):

δ₀:a₁(δ₀)←1

δ₁:a₁(δ₁)←a₁(δ₀)·((b₁·wₐ_{₁}_{,b}_{₁}+b₂·wₐ_{₁}_{,b}_{₂}+b₃·wₐ_{₁}_{,b}_{₃})+ b̅₁̅+̅b̅₂̅+̅b̅₃̅)

δ₂:a₁(δ₂)←a₁(δ₁)·((c₁·wₐ_{₁}_{,c}_{₁}+c₂·wₐ_{₁}_{,c}_{₂}+c₃·wₐ_{₁}_{,c}_{₃})+ c̅₁̅+̅c̅₂̅+̅c̅₃̅)

. . .

δ_{C-1}:a₁(t+1)←a₁(δ_{C-2})·((z₁·wₐ_{₁}_{,c}_{₁}+z₂·wₐ_{₁}_{,c}_{₂}+z₃·wₐ_{₁}_{,c}_{₃})+ z̅₁̅+̅z̅₂̅+̅z̅₃̅)

At the step δ₀, the value of the neuron a₁ at the instant t+δ₀ and is initialized at 1. Then, at the next step δ₁, the result of the preceding step is accumulated in this same neuron with the result of the application of the equation of behavior of the neurons defined here above (see 5.2.1). Then, the new values of the neuron continue to be accumulated until the C clusters have been traversed, i.e. after C steps have ended in an iteration (passing to the instant t+1).

One drawback of this serialization is that a cluster transmits data to itself (since the RIC forms L tracks, when a cluster transmits its information, it will also receive it). However, the inventors have overcome this drawback by including a mechanism of transparency: when a cluster transmits, then it does not receive the data transmitted. In the above equation, this amounts to placing the intermediate result at 1 during the first step (since it is then the first cluster that transmits the information).

However, the inventors have noted that this implementation, although it is valuable from the logic point of view, is sub-optimal. Indeed, it has been observed by attaching numerical values to this architecture, that the gains relative to the non-serialized matrix version (V1.0) are smaller than expected: the reason for this is that a non-negligible part of the gain achieved in terms of computation resources (computation of the value of the neurons and WTA at the level of the cluster) is compensated for by the loss induced by the use of routing resources (each neuron must multiplex one weight among (C−1), thus leading to an L²·C·(C−1) order routing logic). In other words, in this embodiment, the computation logic is shifted, but it is not reduced in the expected proportions.

However, the inventors have had the idea of an optimizing that takes advantage of all the serial versions of the architecture: the use of shift registers to store memory points. This use is described here below.

### 6.2.3.2. Serialisation of Neurons: Serial Neural Matrix Version (V1.2)

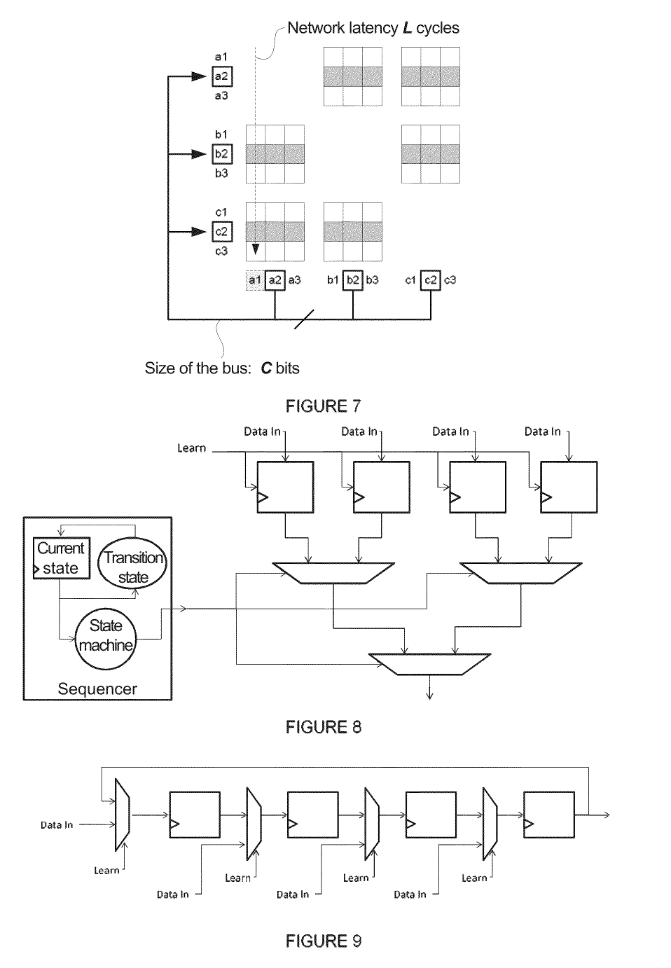

In this embodiment, the updating of the network takes L steps, one step per neuron. At each step, each cluster transmits the value of one and only one of its neurons on the interconnection network (RIC). This value is retrieved by all the neurons of the other clusters. Thus, the RIC comprises C tracks, but each cluster receives only (C−1) tracks (a cluster does not speak to itself). The problem of transparency encountered in the version V1.1 does not arise. The principle is described with reference to FIG. 7.

As in the case of version V1.1 the operating equation is identical to the matrix version (V1), and the serialization makes it possible to pool the computation resources. However, the inventors have also noted that this implementation, although it is interesting from the logic viewpoint, is sub-optimal. Indeed, it has been observed, in assessing the costs of this architecture, that the gains as compared with the non-serialized matrix version (V1.0)] are low: the reason for this is that, as above, a non-negligible part of the gain achieved in terms of computation resources (computation of the value of the neurons and WTA at the level of cluster) is compensated for by a loss caused by the use of routing resources.

### 6.2.3.3. Implementing of Shift Registers (Principle of the Flip-Flop Ring)

Let us assume that four adjacency coefficients have been stored in the adjacency matrix, and that it is sought to access them sequentially (since the architecture is serialized). FIG. 9 represents the logic needed for learning and rendering these adjacency coefficients.

The address (a0, a1) represents the state of the sequencer which is a binary word encoded in One-Hot encoding (a word containing a maximum of only one bit at 1). It is noted that, to pick off the four weights (four flip-flops), it is necessary to implement a relatively heavy multiplexing logic (for L weights it is necessary to have (L−1) MUX2:1).

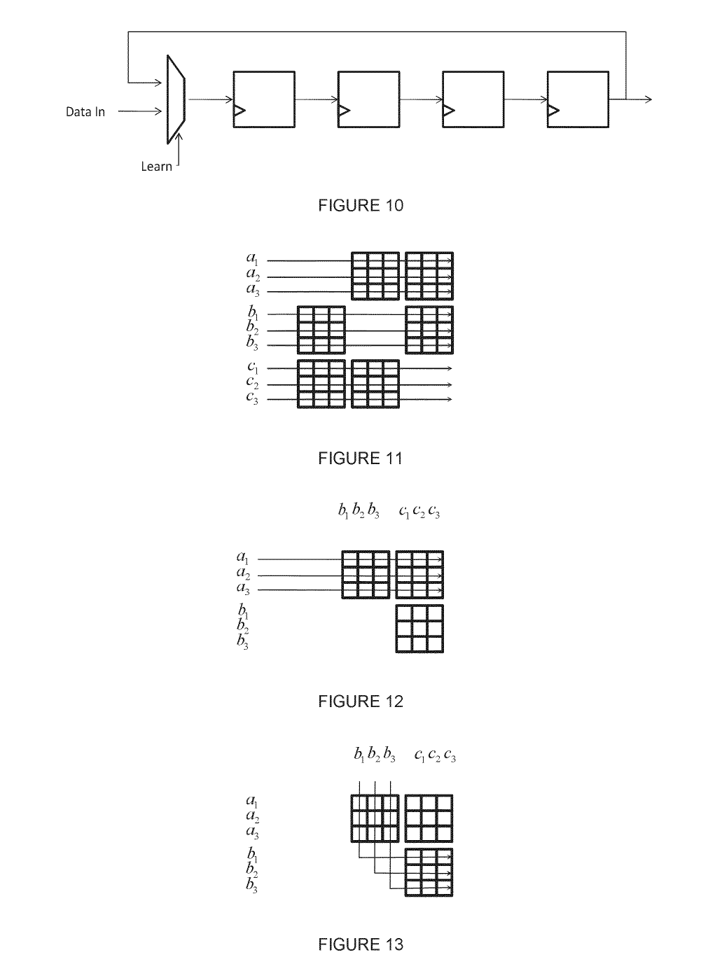

The inventors have found that it is possible to considerably reduce the resources by creating a flip-flop ring: in learning mode, this shift register is filled with the input (data In) presented and in rendering, it copies itself into itself. It suffices therefore, in order to carry out this routing, to have a 2-to-1 multiplexer driven by the learn bit (FIG. 10). This ring is distinguished from the classic shift register (see FIG. 9) by architectural adaptations proposed by the inventors to meet the specific requirements of the invention.

The gain is considerable since the inventors have also been able to eliminate the entire routing logic and since the learning logic is reduced by one order of magnitude. This operation is valid for any type of serialization (by cluster, by neuron or both at a time).

There is thus a drop by one order of magnitude: the resources needed for the routing and the learning pass to an order L²C or LC², depending on whether it is the clusters or the neurons that are serialized. The barrier of L²C² is crossed at the level of the computation resources: thus, through the use of the flip-flop ring according to the invention, only the quantity of memory needed remains at an order of magnitude L²C², all the other resources are at a lower order of magnitude (L or C) and therefore become negligible relative to the memory in an overall assessment.

Thus, when the routing logic is replaced by this shift register, it is observed that the serial cluster versions and the serial neuron versions are equivalent in terms of surface as compared with previous architectures. This is because the drop in non-memory resources below the L²C² limit makes these resources negligible relative to the memory itself, and therefore the resources occupied by the memory form the essential part of the resources of the architecture. The inventors have therefore practically eliminated the resources needed for learning and computation.

6.2.4. Combinations of Optimizations in Memory and Communications

The optimizations relating to computation (i.e. binarization) can be combined without any modification with optimizations targeting the memory (triangularization) or the serialization of the communications. On the contrary, certain combinations of the optimizations targeting the memory and the optimizations targeting the communications require dedicated architectural solutions.

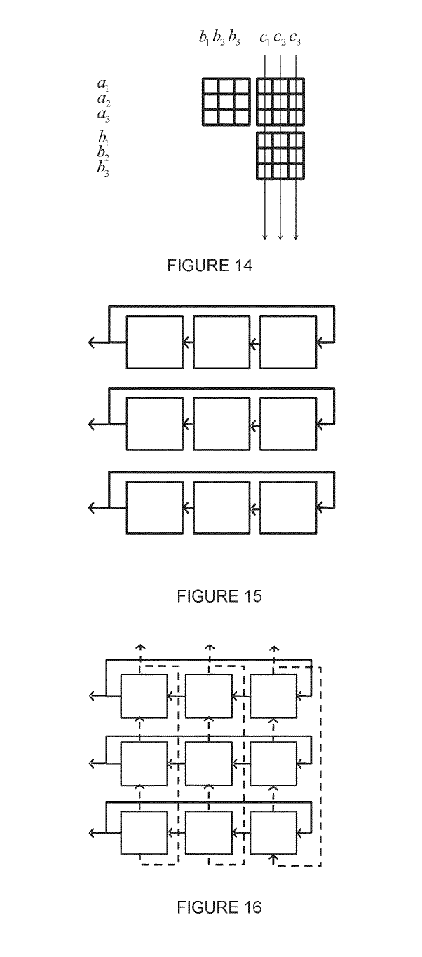

Let us take a neural network of three clusters and three neurons each. FIG. 11 represents the information memorized in a non-triangularized matrix and the way in which to retrieve the information on the neurons of each cluster (row access). FIGS. 13, 14 and 15 represent the way in which respectively the three clusters A, B and C will access the same information in the triangularized matrix according to the approach proposed here above: the cluster A continues to access its information in rows (FIG. 12); the cluster B accesses its information in columns (for the information pooled with that of the cluster A) and in rows for the others (FIG. 12) and finally the information on the cluster C being shared with the clusters A and B, the cluster C will access its data in columns (FIG. 14).

a) Serial Cluster Communications and Parallel Processing:

At an instant t, a single cluster (transmitter) broadcasts the state of all its neurons in parallel and all the other clusters (receivers) receive this information. These clusters access an adjacency matrix in parallel to retrieve their coefficients and locally carry out their processing operations. This mode of communication combines the triangularization of the matrix and the use of the flip-flop ring without problems (see FIG. 15 for an example of use of a flip-flop ring on one of the sub-matrices) since at any instant each receiver cluster accesses only the coefficients of adjacency of its own neurons with the neurons of the sender cluster (sharing of the adjacency matrix common to all the distinct clusters). In this embodiment, therefore, there will be no conflict of access to the adjacency coefficients of the triangular matrix.

b) Serial Cluster Communications and Serial Cluster Processing:

At the instant t, a single cluster broadcasts the state of all its neurons in parallel and all the other clusters (receivers) receive this information. These clusters then access the adjacency matrix in series (one after the other) to retrieve their coefficients and locally carry out their processing operations. This serial access to the matrix makes it possible to pool the computation resources between the clusters. If the matrix is optimized by triangularization, then specific routing resources need to be added. Indeed, in this case, the use of a flip-flop ring as described here above can be applied simply (as illustrated in FIG. 15), the adjacency matrices being shared between clusters and each cluster having to implement a flip-flop ring between all the adjacency matrices; there is a conflict there because the permutations required by a cluster Ci falsify those required by the cluster Cj. In fact, according to the invention, this amounts to implementing this flip-flop ring both on the rows and the columns of the adjacency matrix (see FIG. 16 for an illustration of this principle).

Thus, the rows and the columns are not accessed simultaneously. Two rings are needed: a first ring is used to carry out an access in rows and a second ring is used to carry out an access in columns, as illustrated in FIG. 16.

c) Serial Neural Communication and Parallel Processing:

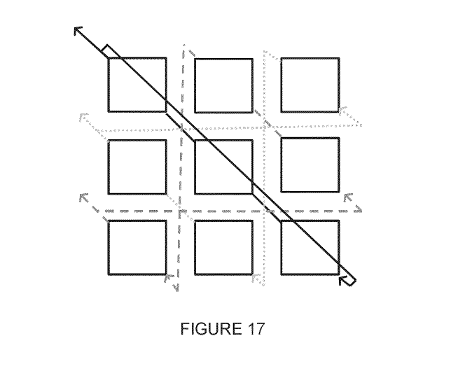

At an instant t, all the clusters broadcast the state of one and only one of their neurons in parallel to all the other clusters. The clusters therefore access their adjacency matrix in parallel to retrieve their coefficients and locally carry out their processing operations. However, in the context of triangularization, since two clusters will access their shared adjacency matrix at the same time, and since they should not traverse it in the same sense, the use of a flip-flop ring to serialize the transfers of information is not trivial. Indeed, in this case, this means that it is necessary to make the flip-flop ring work both on the rows (access required by the cluster Ci) and on the columns (access required by the clusterC,) of the adjacency matrix. In fact, according to the invention, this amounts to implementing this flip-flop ring not on the rows and the columns of the adjacency matrix but on the diagonals (see FIG. 17).

Let M_{Ci, Cj} be an adjacency matrix between two clusters Ci, Cj (or an adjacency matrix block) containing the adjacency coefficients w((_{k,g})(k_{′},g_{′})) which will be denoted as w(i, j); the permutation done by the flip-flop rings is then written as follows:

w(i,j)=w((i+1)mod L,(j+1)mod L);

This permutation offers the immense advantage of enabling the clusters to obtain read access to their coefficients, always in the same memory compartment. It is therefore not required to add additional routing resources and the size and/or number of access points are therefore advantageously reduced. Besides, it is also possible to have only one flip-flop ring whatever the type of access, in rows or in columns, and it is therefore not necessary to duplicate the flip-flop rings.

d) Serial Neural Communications and Serial Cluster Processing:

At the instant t, all the clusters broadcast the state of one and only one of their neurons in parallel to all the other clusters. These clusters access an adjacency matrix in series to retrieve their coefficients and carry out their processing operations locally. In the context of triangularization, two clusters never access their shared adjacency matrix at the same time. Hence even if they do not traverse it in the same sense, there is no particular conflict to be managed provided that two flip-flop rings are used (permutations on the rows for the first matrix and then permutations on the columns for the second matrix). It will be noted that it is also possible to use flip-flop rings diagonally to reduce the cost of this architectural solution.

Any other combination pertaining to the modes of communication or sharing of computations is done via all or part of the four major embodiments proposed here above. They all rely on the simple use of flip-flop rings, combined or diagonally.

6.2.5. Architecture of the Super Neuron Version (Version V2)

In this embodiment, the inventors have modified the interpretation of the theoretical GBNN model. The principle of this embodiment is described with reference to FIG. 10. In a GBNN network, each neuron locally carries out a set of computations on the basis of information transmitted to it (i.e. all the states of the remote neurons) and information stored locally (the states of the connections in the local adjacency matrix). The principle proposed here consists in transmitting, and therefore using in local computations, only information on neurons, n_{i,j} being an active state at the instant t (i.e. a non-zero value υ(n_{i,j,} t)) and belonging to a known cluster.

Unlike in the classic GBNN neural networks, the information transmitted by the remote clusters are no longer the values of their neurons θ(n_{k,g}, t) but the coefficients of their adjacency matrixw_{(i,j)(k,g)} in the generalized equation (part 5.2.1). Indeed, the states of the connections are stored in the adjacency memory of the remote cluster and in the adjacency memory of the local cluster. Thus, when a cluster receives a sequence of values w(_{i,j)(k,g)} of a remote cluster, it must interpret it as a sequence of binary values indicating whether the neuron of the remote cluster or clusters is or are connected or not connected with these local neurons. In fact, all that the local cluster now has to do is to carry out the computation to find out which local neurons are active (i.e. the WTA).

In order to provide different levels of optimization, the super neuron version can be divided into two modes of operation in the GBNN model:
1—Hard decision model: a known cluster at the instant t possesses exactly one active neuron. In other words, an unknown cluster at the instant t possesses either zero active neurons or at least two active neurons (when the WTA cannot make a choice between these at least two neurons).
2—Flexible decision model: in this mode, a cluster known at the instant t possesses at least one active neuron.

In the hard decision model, the pieces of transmitted information are the values of the coefficients of the adjacency matrix for the single active neuron (if not, no value is transmitted or zero values are transmitted).

In the flexible decision model, the information received by the local clusters are the sums or the disjunctions (depending on whether the computation is an integer computation or binary computation) partial or not partial (depending on the embodiment) of the products or conjunctions between the value of an active remote neuron and its coefficient of the corresponding adjacency matrix. Indeed, these computations can be made for each local neuron in the remote clusters since the states of the connections are memorized in the adjacency memory of the remote cluster and the adjacency memory of the local cluster. Thus, the remote cluster does not transmit the values w_{(i,j)(k,g)} of an active neuron but the accumulation of the valuesw_{(i,j)(k,g)} of all its active neurons. Consequently, only the partial result of a local neuron computed in a remote cluster is transmitted to said neuron.

Let us take the example given in part 5.2.1 if it is considered that the cluster B is erased and that the WTA mechanism has determined that the neurons b₁ and b₂ are active whereas in the flexible decision model, the remote cluster B has transmitted the result of the following partial sum to the local cluster A: ((wₐ_{₁}_{,b}_{₁}+wₐ_{₁}_{,b}_{₂})) or equivalently ((b₁(t)·ₐ_{₁}_{,b}_{₁}+b₂(t)·wₐ_{₁}_{,b}_{₂}+b₃(t)·wₐ_{₁}_{,b}_{₃})) or equivalently ((b₁(t)·wₐ_{₁}_{,b}_{₁}+b₂(t)·wₐ_{₁}_{,b}_{₂})) according to the embodiment.

The WTA can then be carried out whatever the mode of decision by the local cluster by using these received results of partial remote computations to determine which are the active local neurons.

Thus, in the case of a Super Neuron, we are no longer in the presence of neurons that exchange their states but in the presence of clusters that transmit a piece of information to the neurons informing them that they are connected or not connected to their active neurons.

Naturally, the optimizations described here above in this document can be combined with this original mode of operation. Thus, the inventors have also taken advantage of the possibility of serializing the transfers of information between clusters to simplify the architecture of computation of the WTA. Indeed, since the local cluster receives coefficients of adjacency of the active neurons of the other clusters, the transfer of this information in series to each of its neurons (serialization) replaces the simultaneous computations of the scores of all the neurons by a computation on the fly of the score of each local neuron concerned. This modification thus enables a drastic reduction of the computation resources needed for the WTA.

Although the present disclosure has been described with reference to one or more examples, workers skilled in the art will recognize that changes may be made in form and detail without departing from the scope of the disclosure and/or the appended claims.

1. A method for obtaining, within a system, a piece of data representing an identifier of one neuron from among a set comprising L neurons called a cluster, L being a natural integer of a value greater than or equal to two, said cluster belonging to a neural network comprising C clusters, C being a natural integer of a value greater than or equal to two, each neuron of said neural network comprising a current state among at least two possible states, each neuron of said neural network belonging to a single cluster, where the method, during an iterative process of transmission of states of neurons between said C clusters of said neural network, for at least one current cluster Cᵢ among said C clusters:
obtaining from the system comprising the neural network a set E of current states of neurons originating from at least one cluster Cⱼ, j≠i;
at least one act of obtaining a set A of coefficients of adjacency between a neuron of said current cluster Cᵢ, and one neuron of a cluster Cⱼ of the neural network j≠i; and
computing, as a function of said state E of states of neurons, said set A of coefficients of adjacency and, as a function of at least one state among the states of said neurons of said current cluster Cᵢ, at least one winning neuron N_{G}, delivering said piece of data representing an identifier of said at least one winning neuron N_{G}.

2. The method according to claim 1, wherein the computing comprises, for a current neuron n_{i,j} of said current cluster Cᵢ, the application of the following formula:
$$ϑ ( {n}_{i , j} , t + 1 ) = {}_{k = 1 , k \neq i}^{C} ( ( {}_{g = 1}^{L} ϑ ( {n}_{k , g} , t ) {w}_{( i , j ) ( k , g )} ) ( \overline{{}_{g = 1}^{L} ϑ ( {n}_{k , g} , t )} ) )$$
wherein: [symbol]
(n_{i,j},t+1) is the state of the neuron n_{i,j} at the instant t+1;
Λ_{k=1,k≠i}^{C}( . . . ) is a conjunction (logic AND) of C−1 non-zero binary elements given by the logic equations applied to all the other clusters of the neural network;
w(_{i,j)(k,g)} is the coefficient of adjacency between the neuron n_{k,g} and the neuron n_{i,j}; [symbol]
(n_{k,g},t) is the state of the neuron n_{k,g} at the instant t;
V_{g=1}^{L} . . . is the operation of disjunction (logic OR) of L binary elements representing the state (active or not active) at the instant t of the neurons of the remote clusters;
( V̅_̅{̅g̅=̅1̅}̅^̅{̅L̅}̅ .̅ .̅ .̅ ) is the operation of complemented disjunction (logic NOR) of L binary elements.

3. The method according to claim 2, wherein the computing comprises selection, from among the neurons of said current cluster Cᵢ, of the neuron N_{G}, the state of which at the instant t+1 is 1.

4. The method according to claim 2, wherein the computing comprises selection, from among the neurons of said current cluster Cᵢ, of the neuron N_{G}, the state of which at the instant t+2 is 1, in applying the following function:
$$ϑ ( {n}_{i , j} , t + 2 ) = {}_{i = 1}^{L} ( ϑ ( {n}_{i} , t + 1 ) Λ {( {}_{\begin{matrix}j = 1 , \\ j \neq l\end{matrix}}^{L} ϑ ( {n}_{j} , t + 1 ) )}^{{\_}^{′}} )$$

5. The method according to claim 1, wherein obtaining a set A of coefficients of adjacency originating from at least one cluster Cⱼ, j≠i comprises a plurality of acts of access to at least one centralized structure for memorizing coefficients of adjacency of neurons of said neurons of said clusters of said neural network.

6. The method according to claim 5, wherein said at least one centralized structure for memorizing coefficients of adjacency of neurons takes the form of a blockwise triangular matrix comprising a number of blocks equal to Σᵢ₌₁^{C-1} i, one block comprising L coefficients of adjacency.

7. The method according to claim 1, wherein the obtaining a set E of states of neurons originating from at least one cluster Cⱼ, j≠i comprises L acts of simultaneous transmission by each cluster Cⱼ, j≠i, of a single state of a single neuron.

8. The method according to claim 1, where in the obtaining a set E of states of neurons originating from at least one cluster Cⱼ, j≠i comprises C acts of simultaneous transmission by each cluster Cⱼ, j≠i, of all the states of the cluster.

9. The method according to claim 7, wherein the obtaining a set E of states of neurons originating from at least one cluster Cⱼ, j≠i comprises, within said current cluster Cᵢ, implementing a shift register of a predetermined size.

10. The method according to claim 1, wherein said at least one cluster Cⱼ, implements at least one part of said of computing and transmits to said cluster Cᵢ, the sum and/or the disjunction of the coefficients of adjacency of these active neurons.

11. A device for obtaining, within a system comprising a neural network, a piece of data representing an identifier of one neuron from among a set comprising L neurons called a cluster, L being a natural integer of a value greater than or equal to two, said cluster belonging to a neural network comprising C clusters, C being a natural integer of a value greater than or equal to two, each neuron of said neural network comprising a current state among at least two possible states, each neuron of said neural network belonging to a single cluster, wherein the device comprises:
means for implementing an iterative process of transmission of states of neurons between said C clusters of said neural network, for at least one current cluster Cᵢ among said C clusters, including:
means for obtaining a set E of current states of neurons originating from at least one cluster Cⱼ, j≠i;
means for obtaining a set A of coefficients of adjacency between one neuron of said current cluster Cᵢ, and one neuron of a cluster Cⱼ of the neural network j≠i; and
means for computing, as a function of said state E of states of neurons, said set A of coefficients of adjacency and as a function of at least one state among states of said neurons of said current cluster Cᵢ, at least one winning neuron N_{G}, delivering said piece of data representing an identifier of said at least one winning neuron N_{G}.

12. A non-transitory computer-readable medium comprising a computer program product recorded thereon and comprising program code instructions execution of a method for obtaining, within a system, a piece of data representing an identifier of one neuron from among a set comprising L neurons called a cluster, when the instructions are executed on a processor, wherein L is a natural integer of a value greater than or equal to two, said cluster belongs to a neural network comprising C clusters, C is a natural integer of a value greater than or equal to two, each neuron of said neural network comprises a current state among at least two possible states, and each neuron of said neural network belongs to a single cluster, wherein the instructions configure the processor to perform the following acts during an iterative process of transmission of states of neurons between said C clusters of said neural network, for at least one current cluster Cᵢ among said C clusters:
obtaining a set E of current states of neurons originating from at least one cluster Cⱼ, j≠i;
at least one act of obtaining a set A of coefficients of adjacency between a neuron of said current cluster Cᵢ, and one neuron of a cluster Cⱼ of the neural network j≠i; and
computing, as a function of said state E of states of neurons, said set A of coefficients of adjacency and, as a function of at least one state among the states of said neurons of said current cluster Cⱼ, at least one winning neuron N_{G}, delivering said piece of data representing an identifier of said at least one winning neuron N_{G}.
